(19) United States
(12) Patent Application Publication
(10) Pub. No.: US 2016/0196157 A1
(43) Pub. Date: Jul. 7, 2016

(54) INFORMATION PROCESSING SYSTEM, MANAGEMENT DEVICE, AND METHOD OF CONTROLLING INFORMATION PROCESSING SYSTEM

(71) Applicant: FUJITSU LIMITED, Kawasaki-shi (JP)

(72) Inventor: Hiroyoshi Kodama, Isehara (JP)

(73) Assignee: FUJITSU LIMITED, Kawasaki-shi (JP)

(21) Appl. No.: 14/977,691

(22) Filed: Dec. 22, 2015

(30) Foreign Application Priority Data
Jan. 5, 2015 (JP) 2015-000304

(51) Int. Cl. G06F 9/455; H04L 29/08; H04L 12/26; H04L 12/24

(52) U.S. Cl. CPC G06F 9/45558; H04L 41/5054; H04L 67/16; H04L 43/04; H04L 43/0876; G06F 2009/4557; G06F 2009/45595; G06F 2009/45591

(57) ABSTRACT

An information processing system includes a plurality of information processing devices that include respectively processors having different operating frequencies, and a management device that manages the plurality of information processing devices. The management device includes a monitoring unit that monitors a usage rate, within a predetermined period, of a virtual machine executed by each of the plurality of information processing devices, and an allocating unit that allocates a virtual machine, the usage rate of which within the predetermined period exceeds a first threshold, to another information processing device, based on the number of processors of each of the plurality of information processing devices, the number of arithmetic processing units of each processor, and an operating frequency of each processor, when the monitoring unit detects that the usage rate, within the predetermined period, of a virtual machines exceeds the first threshold.

### CROSS-REFERENCE TO RELATED APPLICATION

This application is based upon and claims the benefit of priority of the prior Japanese Patent Application No. 2015-000304, filed on Jan. 5, 2015, the entire contents of which are incorporated herein by reference.

### FIELD

The present invention relates to an information processing system, a management device, and a method of controlling the information processing system.

### BACKGROUND

According to a virtualization technique, a hypervisor operating on an information processing device which is a computer or a physical machine (hereinafter, the information processing device will be sometimes referred to as a computer or a physical machine) emulates hardware of the physical machine and activates (or boots) and generates a plurality of virtual machines (or VMs) on the physical machine. The virtualization technique generates a plurality of virtual machines in each of a plurality of physical machines and realizes a service system of a plurality of users. A physical machine on which a virtual machine is activated (or booted) and generated is sometimes referred to as a host machine or simply a host.

In such a virtualization technique, migration of a virtual machine from a source host to a destination host is used when integrating a virtual machine to a certain physical machine or distributing a virtual machine to another physical machine, for example. Examples of migration of a virtual machine include live migration in which a virtual machine operating on a source physical machine is allowed to migrate to another destination physical machine while maintaining an operating state and cold migration in which a virtual machine operating on a source physical machine is temporarily shut down and the virtual machine is activated and generated on a destination physical machine.

In present cloud computing, a plurality of virtual machines is activated and generated in a plurality of physical machines having equivalent performance deployed in a data center (or a server facility) using a virtualization technique. When a virtual machine is activated and generated, a user sets the number of CPU cores and a memory volume that are to be allocated to the virtual machine. According to the setting, a hypervisor allocates the set number of CPU cores and the set memory volume to the virtual machine.

In cloud computing, physical machine groups having different performances may be present in a data center because the physical machine groups are deployed at different time points. In this case, a user selects whether a physical machine group is a physical machine group having a first performance or a physical machine group having a second performance, which is different from the first performance, and sets the number of CPU cores and a memory volume of a virtual machine.

Further, a virtual machine management device monitors operation history of the virtual machine and checks whether the virtual machine is operating while exceeding the processing performance of a certain physical machine. Moreover, the virtual machine management device manages reallocation of the virtual machine as needed. Management of reallocation includes migrating the virtual machine to another physical machine to distribute the load of the physical machine and integrating the virtual machine to a certain physical machine to save power consumption. In this case, activation and generation of virtual machines on the physical machine is performed based on the number of CPU cores and the memory volume set to each of the virtual machines.

The migration is disclosed in Japanese Laid Open Publications 2013-500518, 2007-310791 and 2011-8822.

### SUMMARY

In recent years, a cloud computing service has been provided using physical machines having different performances. For example, a plurality of physical machines having different performances deployed at different time points are integrated to provide a cloud computing service to users. A virtual machine management device manages allocation of virtual machines between a plurality of physical machines having different performances. In this way, all physical machines may be effectively utilized.

In such a case, destination physical machines of a virtual machine are selected in the same manner regardless of whether the physical machine has high or low performance. Thus, virtual machines may concentrate on a physical machine having lower performance, a virtual machine is not to be activated and generated on a physical machine having higher performance, and the power of the physical machine having higher performance may be shut down.

According to an aspect of the disclosure, an information processing system comprises: a plurality of information processing devices that include respectively processors having different operating frequencies; and a management device that manages the plurality of information processing devices, wherein the management device includes: a monitoring unit that monitors a usage rate, within a predetermined period, of a virtual machine executed by each of the plurality of information processing devices; and an allocating unit that allocates a virtual machine, the usage rate of which within the predetermined period exceeds a first threshold, to another information processing device among the plurality of information processing devices, based on the number of processors of each of the plurality of information processing devices, the number of arithmetic processing units of each processor, and an operating frequency of each processor when the monitoring unit detects that the usage rate, within the predetermined period, of any one of the virtual machines exceeds the first threshold.

According to the aspect, since a virtual machine is allocated to a physical machine having processing performance corresponding to a processing amount of the virtual machine, it is possible to enhance the usage rate and processing speed of the physical machine.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system according to the present embodiment;

FIG. 2 is a diagram illustrating a schematic configuration of each of the physical machines 1, 2, and 3;

FIG. 3 is a diagram illustrating a configuration of the shared storage 20 illustrated in FIG. 1;

FIG. 4 is a flowchart illustrating a VM deployment process of a VM management program according to a first embodiment;

FIG. 5 is a diagram illustrating an example of a performance rank table of physical machines;

FIG. 6 is a diagram illustrating an example of a physical machine group table;

FIG. 7 is a diagram illustrating an example of redeployment of virtual machines VMs by the VM deployment process of the VM management program illustrated in FIG. 4 according to the present embodiment;

FIG. 8 is a diagram illustrating an example of a physical machine group table according to the second embodiment;

FIG. 9 is a flowchart of a portion of a virtual machine deployment management program according to the second embodiment;

FIG. 10 is a diagram illustrating an example of a memory performance rank table of physical machines according to the third embodiment;

FIG. 11 is a diagram illustrating an example of a physical machine group table according to the third embodiment; and

FIGS. 12 and 13 are flowcharts illustrating the process of a virtual machine deployment management program according to the third embodiment.

### DESCRIPTION OF EMBODIMENTS

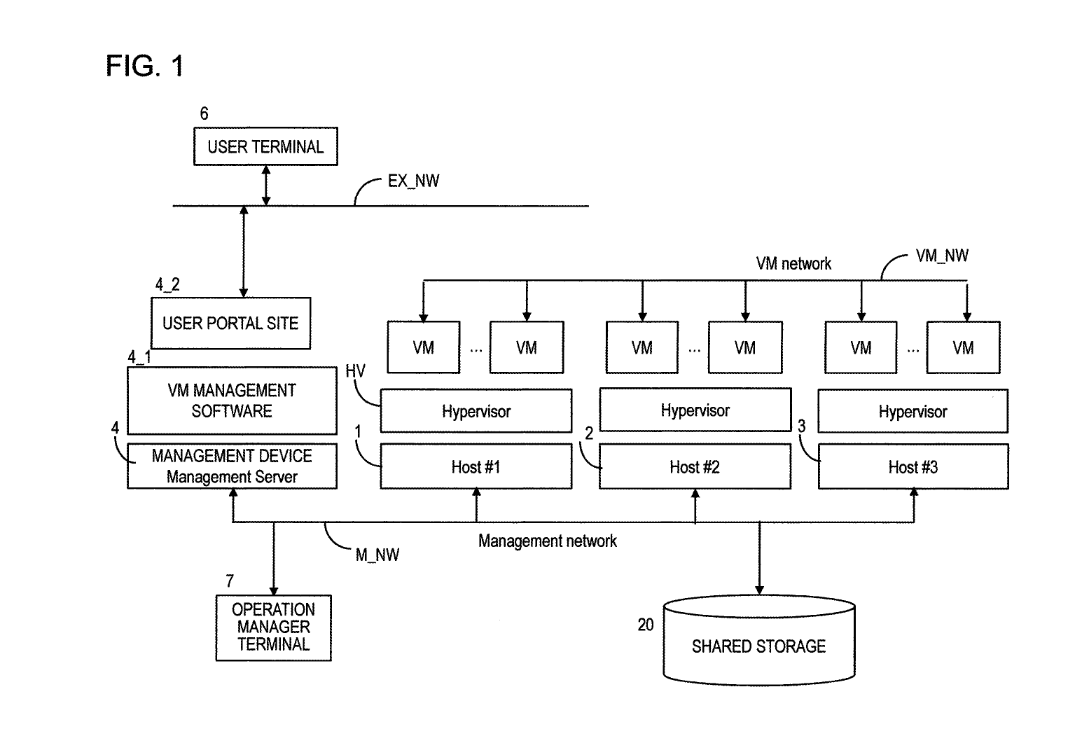

FIG. 1 is a diagram illustrating a configuration of an information processing system according to the present embodiment. An information system includes a plurality of physical machines (or VM hosts) 1, 2, and 3 that executes virtual machines VMs on a hypervisor HV, a management device 4 that manages physical machines and virtual machines, and a shared storage 20. The information system is constructed in a data center (or a server facility) in which a number of physical machines are deployed.

The physical machines (or VM hosts) 1, 2, and 3 execute the hypervisor HV to activate (or boot) and execute one or a plurality of virtual machines VMs. In other words, the hypervisor HV activates and executes the virtual machine VM. The shared storage 20 stores an image file that includes a guest operating system (OS), an application program, and the like of the virtual machine VM. The virtual machine VM loads the guest OS and the application program of the image file stored in the shared storage 20 into the memories of the physical machines 1, 2, and 3 and executes the guest OS and the application program loaded into the memories to construct a desired service system.

VM management software 4_1 of the management device (or server) 4 activates a virtual machine based on configuration information of the hypervisor HV, pauses, resumes and shut down the virtual machine as needed.

The configuration information has information on the number of CPU cores and the memory volume to be allocated to the virtual machine VM.

Moreover, the VM management software 4_1 of the management device 4 collects information on the operation state of a virtual machine from the hypervisor HV and allows the virtual machine to migrate from a physical machine in operation to another physical machine. That is, the VM management software 4_1 has a monitoring unit that collects the operation state of a virtual machine and an allocating unit that migrates a virtual machine to allocate the virtual machine to another physical machine.

Further, the VM management software 4_1 of the management device 4 provides a portal site 4_2 to a user terminal 6 that operates the service system constructed by virtual machines. The user terminal 6 accesses the portal site 4_2 via an external network EX_NW and performs the maintenance management of the service system.

The physical machines 1, 2, and 3, the management device 4, and the shared storage 20 communicates with each other via a management network M_NW. An operation manager terminal 7 of the information processing system accesses the management device 4 via the management network M_NW, for example. Moreover, the user terminal 6 accesses the management device 4 via the portal site 4_2 to issues a request for new activation, shut-down, or the like. Further, the virtual machines VMs communicate with each other via a VM network VM_NW. The virtual machine VM may be connected to a user of a service system accessing a service system constructed by the virtual machines via the external network EX_NW (for example, the Internet or an intranet).

In FIG. 1, the virtual machines VM are illustrated as being directly connected to the VM network VM_NW. However, actually, the virtual machine VM are connected to the VM network VM_NW via a network interface of each of the physical machines 1, 2, and 3. The management network M_NW is also connected to the network interface of each of the physical machines 1, 2, and 3.

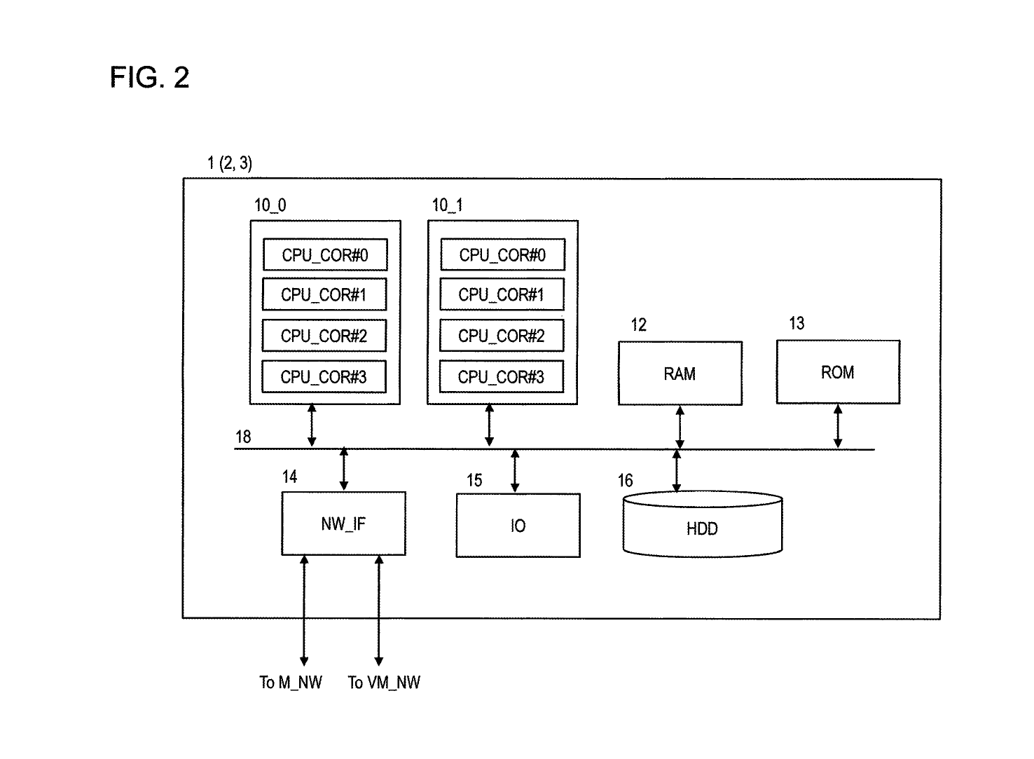

FIG. 2 is a diagram illustrating a schematic configuration of each of the physical machines 1, 2, and 3. For example, each of the physical machines 1, 2, and 3 includes CPUs 10_0 and 10_1 which are processors, a RAM 12 which is a memory, a ROM 13, a network interface (for example, a network interface card (NIC)) 14, an input and output unit 15, and a large-volume storage device 16, e.g., hard-disks, which are connected via a bus 18. Each of the two CPUs 10_0 and 10_1 which are processors includes four CPU cores CPU_COR#1 to #3 which are arithmetic processing units. Thus, the physical machine illustrated in FIG. 2 includes eight CPU cores in total which are arithmetic processing units. In the present embodiment, the numbers of CPUs and CPU cores are not particularly limited to these numbers.

The management device 4 has the same configuration as the configuration of the physical machine illustrated in FIG. 2. The management device 4 executes the VM management software 4_1 to cause the hypervisor HV to activate, shut down, pause, or resume the virtual machine VM. When the VM management software 4_1 is executed by the management device 4, a monitoring unit that monitors the operation state of a virtual machine, and as needed, an allocating unit that migrates a virtual machine from a certain physical machine to another physical machine to redeploy the virtual machine are constructed in the management device 4.

In the case of the physical machines 1, 2, and 3, the large-volume storage device 16 stores an OS, the hypervisor HV, and the like, for example. In the case of the management device 4, the large-volume storage device 16 stores an OS, the VM management software 4_1, and the like, for example. The OS and software stored in the large-volume storage device 16 are loaded into the RAM 12 which is a memory and are executed by the respective CPU cores.

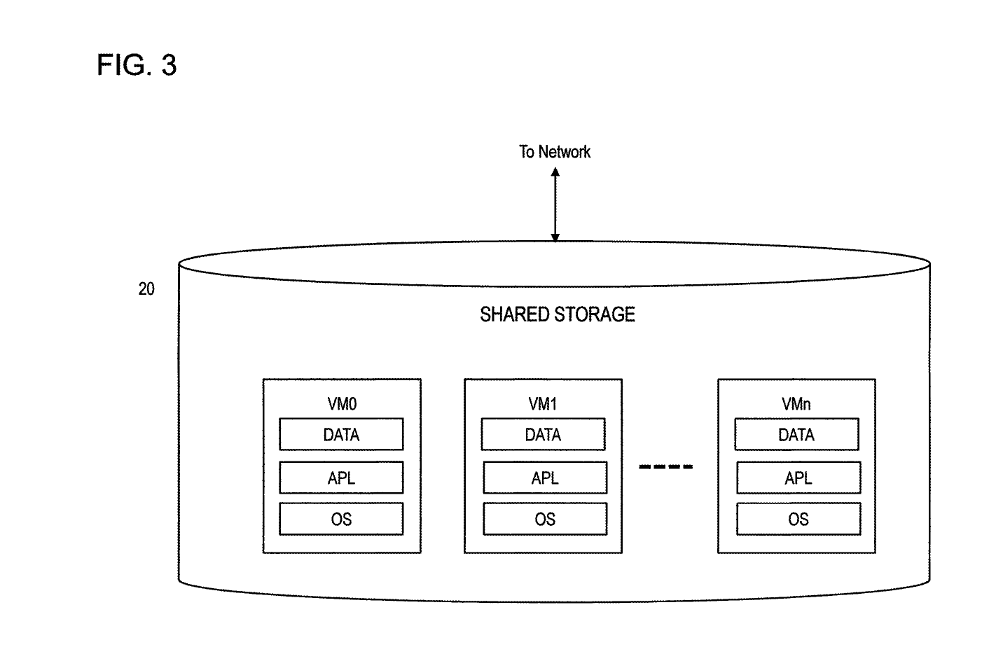

FIG. 3 is a diagram illustrating a configuration of the shared storage 20 illustrated in FIG. 1. The shared storage 20 stores the image file of the virtual machines VMs generated in each of the physical machines 1, 2, and 3. The image file of the virtual machines VM includes a guest OS, an application APL, various items of data DATA, and the like, for example. The items of data DATA include an emulation state and the like of hardware including the I/O state described above, for example.

The hypervisor HV of each of the physical machines 1, 2, and 3 activates a virtual machine corresponding to the image file in the shared storage 20 in response to a command to create a virtual machine VM from the VM management software 4_1 of the management device 4 to execute the virtual machine VM. Moreover, the hypervisor HV pauses, resumes, or shuts down a virtual machine VM in execution in response to a command to pause, resume, or shut down a virtual machine from the VM management software 4_1.

### First Embodiment

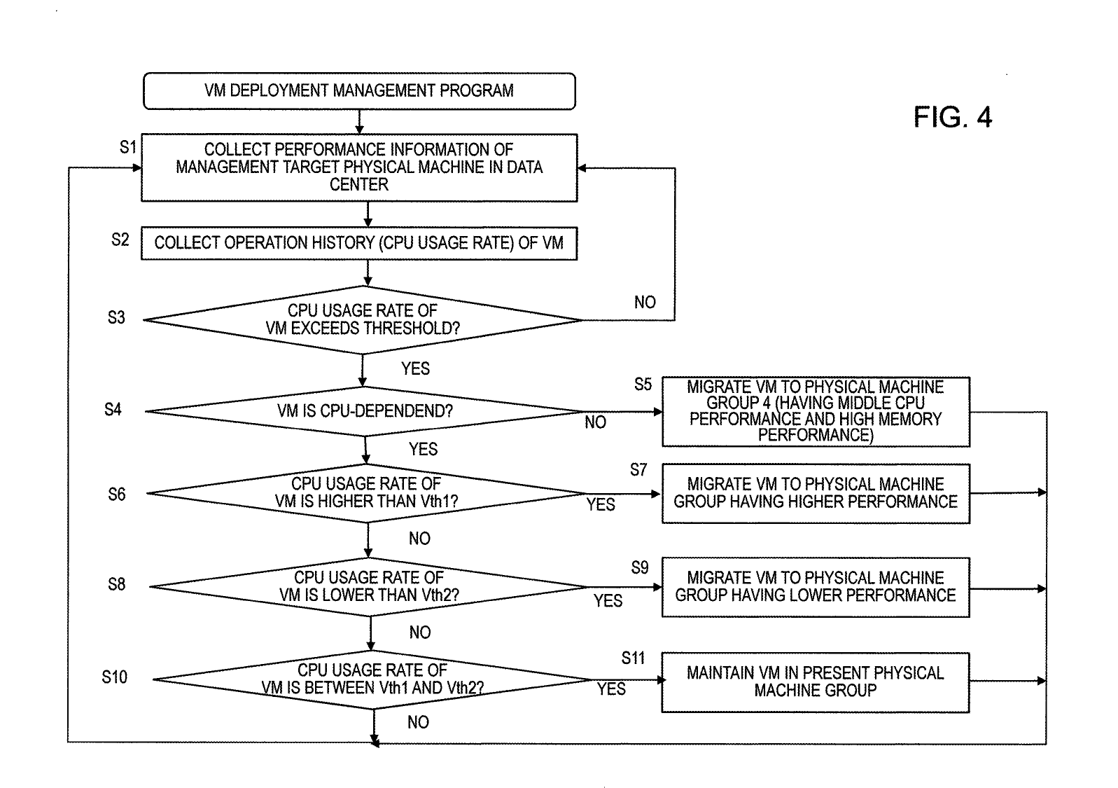

FIG. 4 is a flowchart illustrating a VM deployment process of a VM management program according to a first embodiment. The VM deployment process of the VM management program is executed when the management device 4 executes the VM management program.

First, the management device 4 executes the VM management program 4_1 to collect the performance information of management target physical machines in a data center (S1). Examples of the performance information of physical machines include the number of CPUs (the number of CPU chips), the number of CPU cores in each CPU, an operating frequency of a CPU, a memory volume, an operating frequency of a memory, and the like. The performance information may be collected by the management device 4 issuing an inquiry to each physical machine. Alternatively, the performance information may be read from a storage device in which the performance information is stored when the performance information of physical machines in the data center is exactly managed. Since physical machines in the data center are replaced, added, and discarded each day, it needs to collect the latest information.

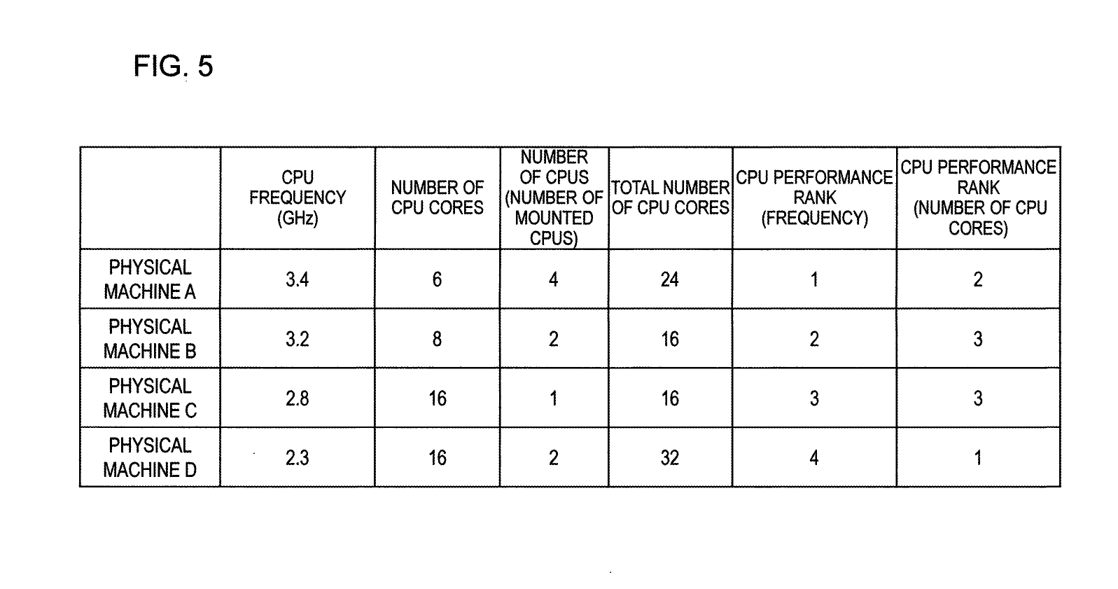

FIG. 5 is a diagram illustrating an example of a performance rank table of physical machines. In the first embodiment, the management device 4 collects the operating frequencies of CPUs in particular and creates such a performance rank table of physical machines as illustrated in FIG. 5. The performance rank table illustrated in FIG. 5 includes a CPU frequency of each of physical machines A to D collected in the collection step S1, the number of CPU cores of each CPU, and a total number of CPU cores calculated by (number of CPUs)×(number of CPU cores). In the example of FIG. 5, firstly, the performance ranks of physical machines are determined based on a CPU performance rank, and ranks 1 to 4 are allocated in descending order of CPU frequencies, in particular. Secondly, the performance ranks of physical machines may be determined in descending order of numbers of CPU cores.

Although FIG. 5 illustrates four physical machines as an example, a number of physical machines are deployed in a general data center. In the present embodiment, it is assumed that a plurality of physical machines in a data center do not always have the same CPU performance (a CPU operating frequency, the number of CPU cores, and the like). That is, physical machines having various CPU performances exist. Similarly, a plurality of physical machines in a data center do not always have the same memory performance (a memory operating frequency, a memory volume, or the like). That is, physical machines having various memory performances exist.

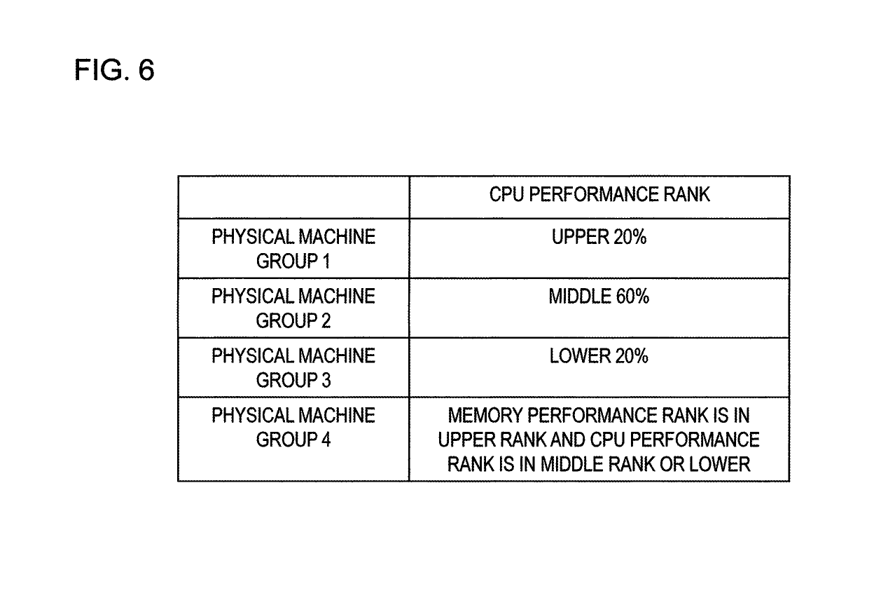

FIG. 6 is a diagram illustrating an example of a physical machine group table. The management device 4 creates a performance rank table of physical machines in the physical machine performance information collection step 51. In the first embodiment, the management device 4 classifies physical machines into four groups based on the CPU performance rank in the physical machine performance rank table illustrated in FIG. 5. For example, a physical machine group 1 is made up of physical machines of which the CPU performance rank is in the upper 20% rank. A physical machine group 2 is made up of physical machines of which the CPU performance rank is in the middle 60% rank, and a physical machine group 3 is made up of physical machines of which the CPU performance rank is in the lower 20% rank.

Further, a physical machine group 4 is made up of physical machines of which the memory performance rank is in the upper rank and the CPU performance rank is in the middle rank or lower. Here, the memory performance rank is determined based on a memory volume and a memory operating frequency, for example. As an example, the memory performance rank is determined based on an index obtained by adding a memory volume and a memory operating frequency with predetermined weight factors. Alternatively, the memory performance rank is determined based on a memory volume. Alternatively, the memory performance rank is determined based on a memory operating frequency.

Returning to FIG. 4, the management device 4 executes the VM management program 4_1 to collect the operation history of a virtual machine VM in operation (S2). The examples of the operation history include a CPU usage rate, a memory usage rate, or the like in a predetermined period. In the first embodiment, the CPU usage rate in particular is collected.

The CPU usage rate is expressed by the following equation, for example.

(CPU usage rate)=(MIPS value needed for execution of VM processing)/(MIPS value possessed by CPU core)

Here, the MIPS value indicates an average speed of an arithmetic instruction such as addition, subtraction, multiplication, or division of CPUs and a memory access instruction such as load or store, and is the unit indicating how many million instructions (steps) can be executed per second. The CPU usage rate can be calculated from the value of a counter that counts the number of processed instructions, provided in each CPU core of the CPU. The CPU usage rate of each CPU core is generally acquired by issuing an inquiry to an OS. In response to the inquiry, the OS reads a counter value in the CPU core and returns a result calculated according to the equation described above. Thus, the CPU usage rate of a virtual machine VM is acquired from a counter value of a certain CPU core allocated to the virtual machine VM.

Moreover, the memory usage rate is expressed by the following equation, for example.

(Memory usage rate)=(Data volume to be stored)/(Memory volume)

That is, the memory usage rate is an index indicating how many percents of a given memory volume is used for storage of data. Thus, the OS acquires the memory usage rate from a counter that counts the data volume, provided in a memory controller, for example.

Subsequently, the management device 4 determines whether the CPU usage rate of a virtual machine exceeds a threshold. The processes of S1 and S2 are repeated if the CPU usage rate does not exceed the threshold, and virtual machine VM redeployment control described later is executed if the CPU usage rate exceeds the threshold (S3). In the first embodiment, the management device 4 sets a higher threshold Vth1 and a lower threshold Vth2 as the threshold. For example, the higher threshold Vth1 corresponds to a CPU usage rate of 85% and the lower threshold Vth2 corresponds to a CPU usage rate of 50%. A CPU usage rate of a virtual machine exceeding the thresholds Vth1 and Vth2 means that the CPU usage rate is higher than the higher threshold Vth1 or the CPU usage rate is lower than the lower threshold Vth2.

The management device 4 redeploys a virtual machine VM from a present physical machine to another physical machine according to the following algorithm. First, the management device 4 determines whether a virtual machine VM is CPU-dependent (S4). If the virtual machine VM is not CPU-dependent (S4: NO), the management device 4 migrates the virtual machine to a physical machine of the physical machine group 4 (S5). Here, a virtual machine being CPU-dependent means that the CPU usage rate thereof is lower than a standard usage rate of a general virtual machine as compared to the memory usage rate. That is, a virtual machine VM of which the CPU usage rate is excessively low but the memory usage rate is high is determined to be non-CPU-dependent.

Such a virtual machine VM may process a small amount of CPU instructions, have a large amount of data stored in a memory, and mainly perform memory access. In contrast, a virtual machine VM having a relatively high CPU usage rate but a low memory usage rate is determined to be CPU-dependent. General virtual machines VMs are CPU-dependent. The processing speed of such a normal virtual machine VM mainly depends on the number of processes per unit time of the CPU (that is, the operating frequency of the CPU).

As described in FIG. 6, the physical machine group 4 is a peculiar physical machine group of which the memory performance rank, which increases as the memory volume increases or as the memory operating frequency increases, is in the upper rank and the CPU performance rank is in the middle rank or lower. First, the management device 4 redeploys a virtual machine VM which is not CPU-dependent in the physical machine group 4.

Subsequently, the management device 4 redeploys general virtual machines VMs which are CPU-dependent in the physical machine groups 1, 2, and 3 in the following manner. Firstly, when it is determined that the CPU usage rate, within a predetermined period, of the virtual machine VM is higher than the higher threshold Vth1 (S6: YES), the management device 4 migrates the virtual machine VM to a physical machine belonging to a physical machine group having a higher performance (for example, a higher CPU operating frequency) than a physical machine group to which a physical machine in execution belongs (S7). For example, the virtual machine VM migrates to a physical machine group of which the performance is one step higher than the present physical machine group.

Secondly, when it is determined that the CPU usage rate, within a predetermined period, of the virtual machine is lower than the lower threshold Vth2 (S8: YES), the management device 4 migrates the virtual machine VM to a physical machine belonging to a physical machine group having a lower performance (for example, a lower CPU operating frequency) than a physical machine group to which a physical machine in execution belongs (S9). For example, the virtual machine VM migrates to a physical machine group of which the performance is one step lower than the present physical machine group.

Thirdly, when it is determined that the CPU usage rate, within a predetermined period, of the virtual machine is between the first and second thresholds Vth1 and Vth2 (S10: YES), the management device 4 maintains the virtual machine VM in a physical machine group of a physical machine in execution (S11).

The management device 4 repeats the processes of S1 to S11.

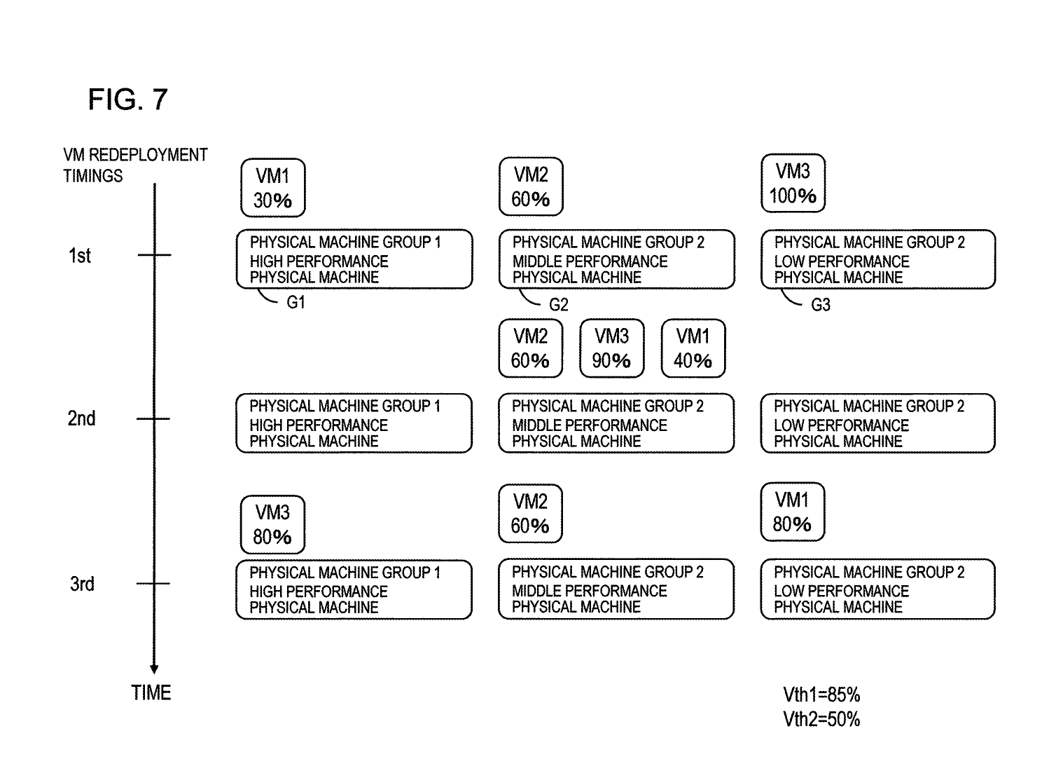

FIG. 7 is a diagram illustrating an example of redeployment of virtual machines VMs by the VM deployment process of the VM management program illustrated in FIG. 4 according to the present embodiment. The time axis is on the left side, and the drawing illustrates an example of the CPU usage rates of the virtual machines VM1, VM2, and VM3 at three redeployment timings of virtual machines VMs and how the management device 4 migrates the virtual machines VMs between the physical machine groups 1, 2, and 3 (G1, G2, and G3). The physical machine groups 1, 2, and 3 have such differences as described in FIG. 6.

First, in the first redeployment process, the monitoring unit (not illustrated) of the management device 4 detects that the CPU usage rates of the virtual machines VM1, VM2, and VM3 are 30%, 60%, and 100%, respectively. Thus, the allocating unit (not illustrated) of the management device 4 migrates the virtual machine VM1 of which the CPU usage rate is 30% (<Threshold Vth2, 50%) from the present physical machine group 1 (G1) to the physical machine group 2 (G2) of which the CPU performance (for example, the CPU operating frequency) is one step lower than that of the present physical machine group and migrates the virtual machine VM3 of which the CPU usage rate is 100% (>Threshold Vth1, 85%) from the present physical machine group 3 (G3) to the physical machine group 2 (G2) of which the performance (for example, the CPU operating frequency) is one step higher than that of the present physical machine group. Further, the management device 4 maintains the virtual machine VM2 of which the CPU usage rate is 60% (Threshold Vth1≧60%≧Vth2) in the present physical machine group 2.

Subsequently, in the second redeployment process, the management device 4 detects that the CPU usage rates of the virtual machines VM1, VM2, and VM3 are 40%, 60%, and 90%, respectively. With the first redeployment process, since the virtual machine VM1 has migrated to a physical machine of the physical machine group 2 having the middle performance lower than the previous performance, the CPU usage rate thereof has increased. In contrast, since the virtual machine VM3 has migrated to a physical machine of the physical machine group 2 having the middle performance higher than the previous performance, the CPU usage rate thereof has decreased. Thus, the allocating unit of the management device 4 migrates the virtual machine VM1 of which the CPU usage rate is 40% (<Threshold Vth2, 50%) to the physical machine group 3 (G3) of which the performance (for example, the CPU operating frequency) is one step lower than that of the present physical machine group 2 (G2) and migrates the virtual machine VM3 of which the CPU usage rate is 90% (>Threshold Vth1, 85%) to the physical machine group 1 (G1) of which the performance (for example, the CPU operating frequency) is one step higher than that of the present physical machine group 2 (G2). The management device 4 maintains the virtual machine VM2 of which the CPU usage rate is 60% in the same physical machine group 2 as the previous time.

Finally, in the third redeployment process, the management device 4 detects that the CPU usage rates of the virtual machines VM1, VM2, and VM3 are 80%, 60%, and 80%, respectively. With the second redeployment process, since the virtual machine VM1 has migrated to a physical machine of the physical machine group 3 having the low performance lower than the previous performance, the CPU usage rate thereof has increased. In contrast, since the virtual machine VM3 has migrated to a physical machine of the physical machine group 1 having the high performance higher than the previous performance, the CPU usage rate thereof has decreased. The CPU usage rates of the virtual machines are between the first threshold Vth1 (=85%) and the second threshold Vth2 (=50%). Thus, in the third redeployment process, the management device 4 maintains the physical machine groups that activate and execute the three virtual machines VM1, VM2, and VM3.

As a result, in the example of FIG. 7, the virtual machine VM1 having a low CPU usage rate at the first redeployment timing has migrated to a physical machine of the physical machine group 3 having the lowest performance through the first and second redeployment processes so that the CPU usage rate thereof became an optimal level of 80%. Similarly, the virtual machine VM3 having a high CPU usage rate at the first redeployment timing has migrated to a physical machine of the physical machine group 1 having the highest performance through the first and second redeployment processes so that the CPU usage rate thereof became an optimal level of 80%.

The CPU usage rates within a predetermined period of the respective virtual machines detected at the third redeployment timing are between the first and second thresholds Vth1 and Vth2, and the three virtual machines VM1, VM2, and VM3 migrate to physical machines having a performance (for example, the CPU operating frequency) ideal for the respective processing amounts. Thus, the deployment of the three virtual machines VM1, VM2, and VM3 to physical machines is optimized and the processes of the three virtual machines are performed at an optimal speed.

In the redeployment process, the management device 4 determines migration of virtual machines on condition that the number of CPU cores and the memory volume allocated to a migration target virtual machine VM are smaller than the number of available CPU cores and the available memory volume of a destination physical machine. That is, in the first embodiment, the management device 4 controls a virtual machine to migrate to a physical machine having a CPU operating frequency ideal for the present CPU usage rate of the virtual machine based on the CPU operating frequency of each physical machine. Moreover, the management device 4 controls a virtual machine to migrate to a physical machine, which can allocate the number of CPU cores and a memory volume need for the virtual machines, based on the number of CPU cores and the memory volume in each physical machine.

Moreover, the CPU usage rate of the virtual machine VM changes dynamically depending on a busy level of the service system constructed by virtual machines VMs. Thus, when the CPU usage rates of the virtual machines VMs change at the fourth redeployment timing, the management device 4 executes migration control so that a virtual machine migrates to a physical machine group having the optimal CPU performance illustrated in FIG. 4.

### Second Embodiment

In the first embodiment, physical machine groups are classified in performance order based on the CPU operating frequency of a physical machine. When the CPU usage rate, within a predetermined period, of a virtual machine is higher than or exceeds the first threshold Vth1 and a number of CPU cores and a memory volume newly allocatable to a destination physical machine are present, the management device 4 migrates the virtual machine to a physical machine in a physical machine group having a higher CPU operating frequency. In this way, it is possible to eliminate the possibility of a processing delay resulting from the CPU usage rate of a virtual machine temporarily exceeding 100% and to deploy the virtual machine to an optimal physical machine. As a result, the process of the virtual machine is made efficient and accelerated.

In contrast, in the second embodiment, physical machine groups are classified based on the number of CPU cores of a physical machine in addition to classifying the physical machine groups in performance order based on the CPU operating frequency. The destination of a virtual machine is determined using the index of the number of CPU cores of the physical machine.

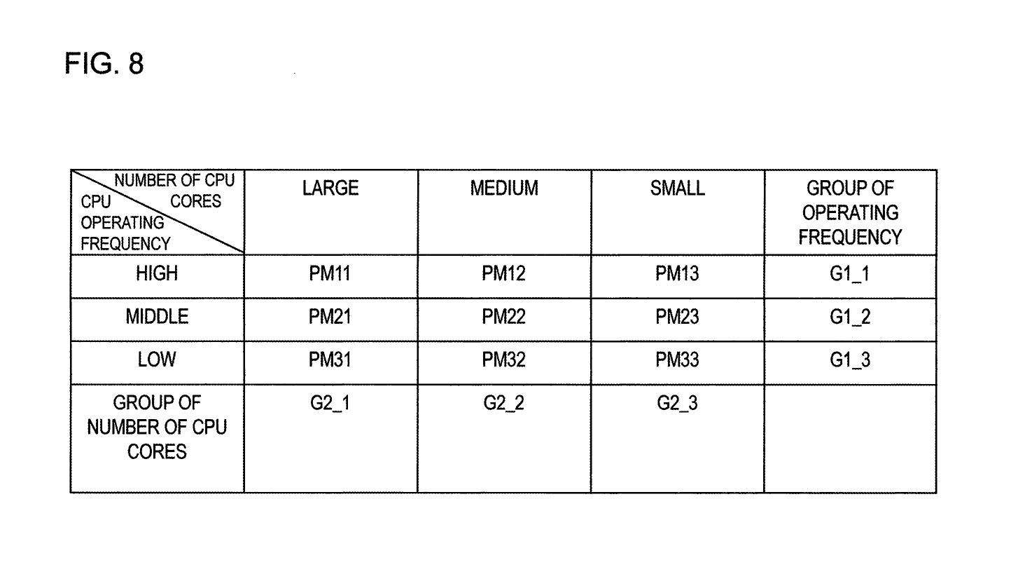

FIG. 8 is a diagram illustrating an example of a physical machine group table according to the second embodiment. The CPU operating frequency is classified into three groups of high, medium, and low along the vertical direction of the table. Moreover, the number of CPU cores of a physical machine is classified into three groups of large, medium, and small along the horizontal direction of the table. Thus, physical machines are classified into nine (3×3=9) physical machine groups.

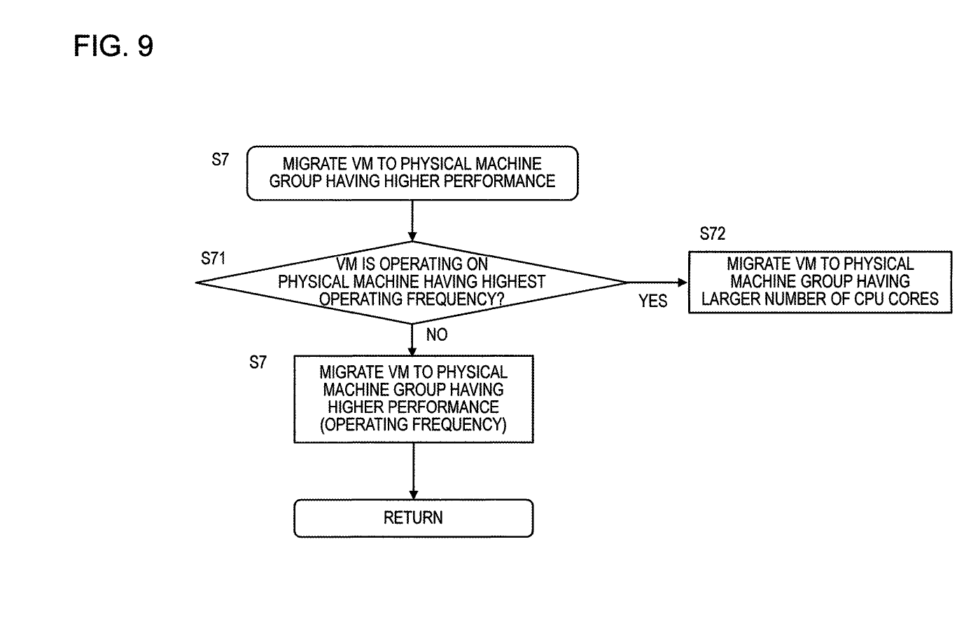

FIG. 9 is a flowchart of a portion of a virtual machine deployment management program according to the second embodiment. The flowchart of FIG. 9 illustrates the process of step S7 in FIG. 4. In FIG. 4, when the CPU usage rate of a virtual machine VM is higher than the first threshold Vth1 (S6: YES), the virtual machine VM migrates to a physical machine group having a higher performance (for example, a higher CPU operating frequency).

In contrast, according to FIG. 9, when the CPU usage rate of a virtual machine is higher than the first threshold Vth1 in FIG. 4 (S6: YES), if the virtual machine VM is already operating in a physical machine group (the group of PM11, PM12, and PM13 or the group G1_1 in FIG. 8) having the highest CPU operating frequency, a physical machine group having the higher CPU operating frequency is not present. Thus, when the virtual machine VM is already operating on a physical machine having the highest CPU operating frequency (S71: YES), the management device 4 migrates the virtual machine to a physical machine of a physical machine group having a larger number of CPU cores (S72). That is, virtual machines migrate from physical machine groups PM12 and PM13 in FIG. 8 to physical machine groups PM11 and PM12 having larger numbers of CPU cores, respectively. In this case, the CPU usage rates of the virtual machines after migration may decrease. The reasons therefor will be described below.

That is, when a plurality of virtual machines are operating on a physical machine, a number of CPU cores may be overcommitted to each virtual machine. Over-commitment occurs when the physical machine has N of CPU cores total, but the sum of the numbers of CPU cores committed to be allocated to a plurality of virtual machines exceeds N. That is, when the sum of the numbers of numbers of CPU cores allocated to virtual machines is larger than the sum N of the actual number of CPU cores of a physical machine, a situation in which a number of CPU cores smaller than the set number of CPU cores are allocated to some virtual machines may occur.

Due to the over-commitment, a situation in which, even when a virtual machine has migrated to a physical machine group having the highest CPU operating frequency, a number of CPU cores smaller than the set number of CPU cores are allocated and so the CPU usage rate does not decrease may occur.

Thus, in the second embodiment, the management device 4 migrates the virtual machine to a physical machine group having a larger number of CPU core in step S72. By doing so, a situation in which the CPU usage rate of the virtual machine is not improved due to the over-commitment of CPU cores may be eliminated or solved.

Returning to FIG. 9, if the virtual machine has not migrated to a physical machine group having the highest CPU operating frequency, the management device 4 migrates the virtual machine to a physical machine group having a higher CPU operating frequency similarly to FIG. 4.

### Third Embodiment

The management device 4 according to a third embodiment controls migration of virtual machines based on a memory usage rate of a virtual machine and a memory volume and a memory operating frequency of a physical machine.

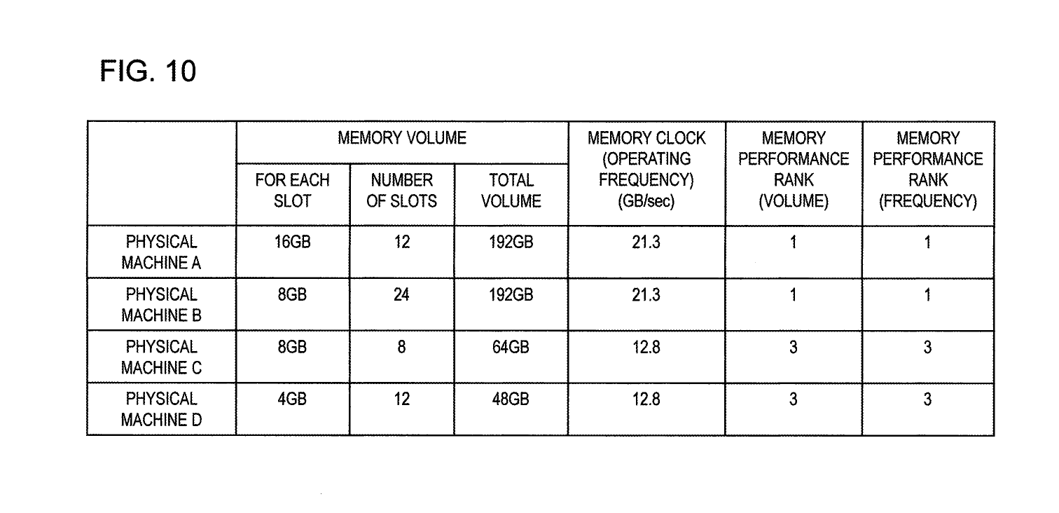

FIG. 10 is a diagram illustrating an example of a memory performance rank table of physical machines according to the third embodiment. In the example of FIG. 10, a physical machine A has a total memory volume of 192 GB for twelve slots (16 GB for each slot) and a memory clock (a memory operating frequency) of 21.3 GB/sec. The physical machines B, C, and D have such performance as illustrated in the table.

In this case, when the memory performance rank is determined based on the memory volume, the physical machines A and B are on the first rank and the physical machines C and D are on the third rank. Similarly, when the memory performance rank is determined based on the memory operating frequency, the physical machines A and B are on the first rank and the physical machines C and D are on the third rank. In the example of FIG. 10, although the same memory performance ranks are obtained, the same ranks are not always be obtained in practical physical machine groups.

In the third embodiment, it is assumed that a plurality of physical machines in a data center do not always have the same CPU performance (a CPU operating frequency, the number of CPU cores, and the like). That is, physical machines having various CPU performances exist. Similarly, a plurality of physical machines in a data center do not always have the same memory performance (a memory operating frequency, a memory volume, or the like). That is, physical machines having various memory performances exist.

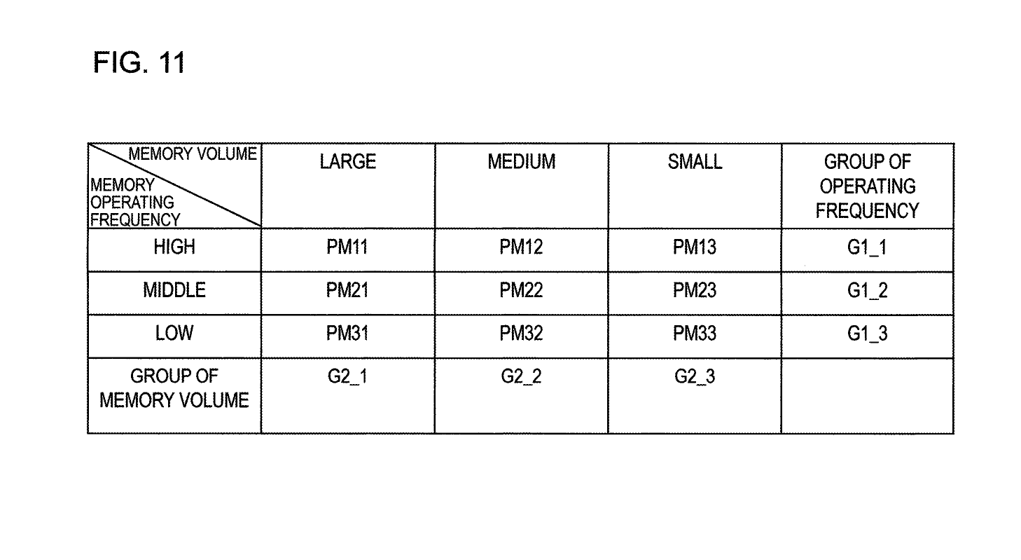

FIG. 11 is a diagram illustrating an example of a physical machine group table according to the third embodiment. In the example of FIG. 11, similarly to FIG. 8, the memory operating frequency is classified into three groups of high, medium, and low along the vertical direction of the table. Moreover, the memory volume of a physical machine is classified into three groups of large, medium, and small along the horizontal direction of the table. Thus, physical machines are classified into nine (3×3=9) physical machine groups.

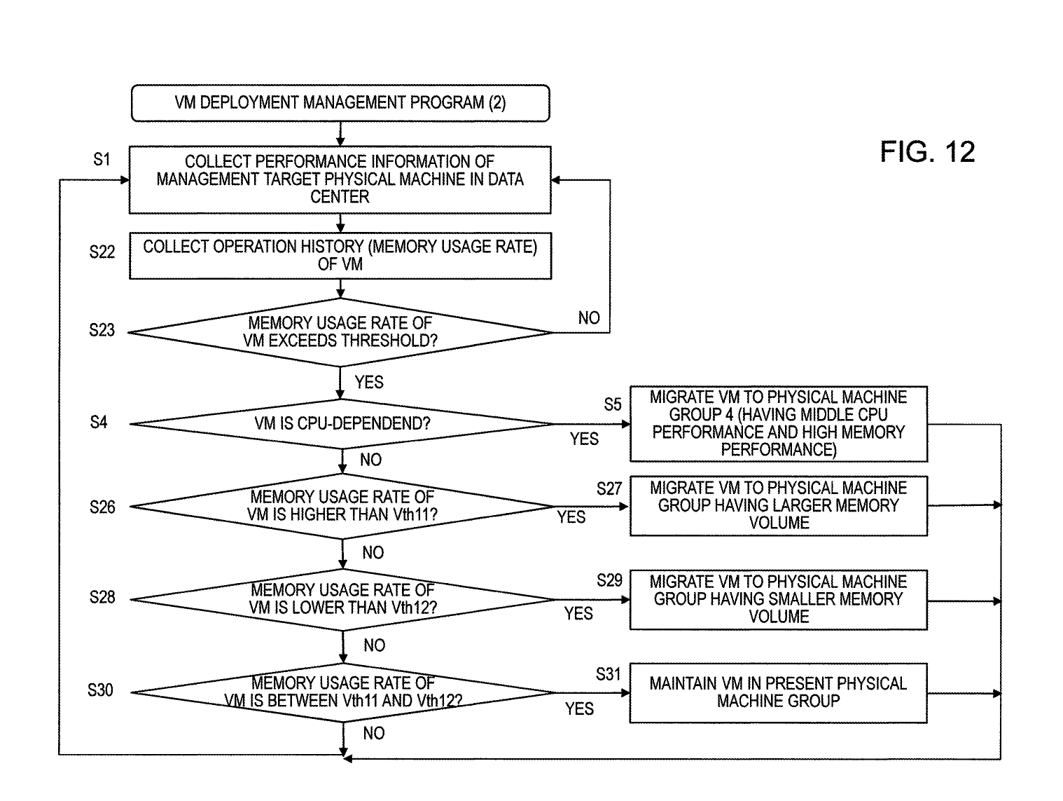

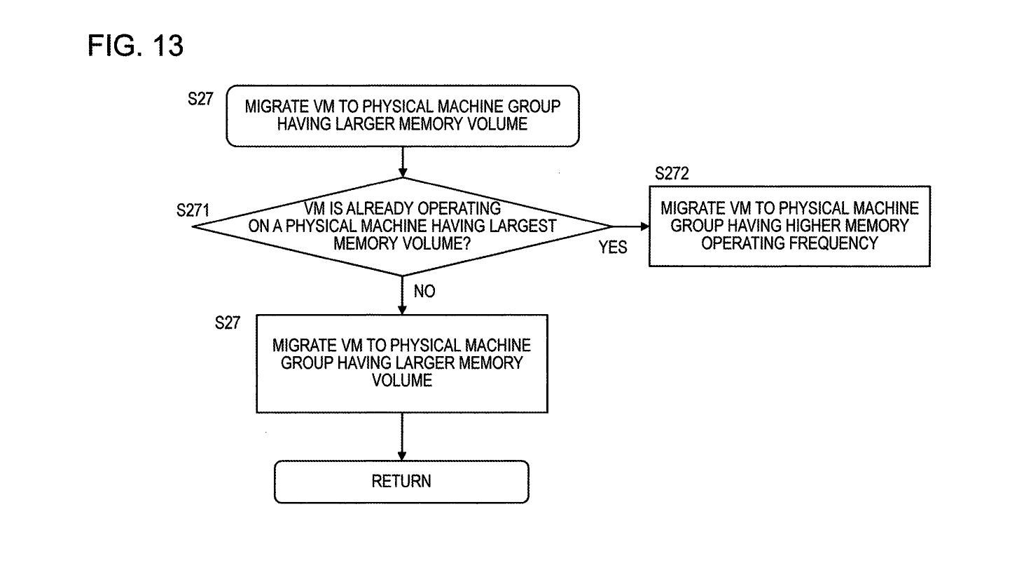

FIGS. 12 and 13 are flowcharts illustrating the process of a virtual machine deployment management program according to the third embodiment. The processes of steps S1, S4, and S5 are the same as those of FIG. 4. The other process steps will be described below.

The management device 4 executes a virtual machine deployment management program of the virtual machine management program 4_1 to collect the memory usage rates of virtual machines as the operation history of virtual machines VMs (S22). Here, the memory usage rate is expressed by the following equation as described above.

(Memory usage rate)=(Data volume to be stored)/(Memory volume)

Thus, the memory usage rate of a virtual machine changes each time. Moreover, qualitatively, the higher the memory usage rate, the larger the data amount and the higher the frequency of access to a memory.

Moreover, when the memory usage rate of a virtual machine exceeds the thresholds Vth11 and Vth12 (S23: YES), the management device 4 performs deployment control of virtual machines to physical machines.

In virtual machines, the over-commitment issue also occurs with regard to the memory volume similarly to the number of CPU cores. That is, when the sum of memory volumes set to virtual machines generated and operated in a certain physical machine exceeds the total memory volume of the physical machine, a virtual machine to which the set memory volume is not allocated may be present. In particular, when the memory usage rate of a plurality of virtual machines operating on a physical machine increases, the sum of the memory volumes of the virtual machines may exceed the limited memory volume of the physical machine and the memory volume is allocated on a first-come-first-served basis. As a result, the set memory volume is not allocated to some virtual machines, and the memory usage rate of such a virtual machine increases because the memory volume which is the denominator of the above-described expression is small. If the memory usage rate increases too high, the processing speed of the virtual machine decreases.

Thus, in the third embodiment, when the memory usage rate, within a predetermined period, of a virtual machine is higher than the first threshold Vth11, the management device 4 migrates the virtual machine to a physical machine of a physical machine group having a larger memory volume. By doing so, it is possible to eliminate the occurrence of a situation in which the memory usage rate increases because the allocated memory volume is smaller than the set value due to over-commitment. In contrast, when the memory usage rate, within a predetermined period, of a virtual machine is lower than the second threshold Vth12 (<Vth11), the management device 4 migrates the virtual machine to a physical machine of a physical machine group having a smaller memory volume. In this way, it is possible to suppress the occurrence of an over-commitment issue in a source physical machine.

Further, in the third embodiment, when the memory usage rate of a virtual machine does not decrease even when the virtual machine migrates to a physical machine having the largest memory volume, since the over-commitment issue does not occur, the management device 4 migrates the virtual machine to a physical machine of a physical machine group having a higher memory operating frequency. Since a high memory usage rate means that there are a large amount of data to be stored, the number of accesses to the memory tends to increase in a qualitative sense. Thus, the management device 4 migrates the virtual machine to a physical machine having a higher memory operating frequency. By doing so, it may be possible to shorten the latency in the memory access of the virtual machine and to improve the processing speed.

Returning to FIG. 12, when the memory usage rate of the virtual machine is higher than the first threshold Vth11 (S26: YES), the management device 4 migrates the virtual machine to a physical machine group having a larger memory volume (S27). On the other hand, when the memory usage rate of the virtual machine is lower than the second threshold Vth12 (S28: YES), the management device 4 migrates the virtual machine to a physical machine group having a smaller memory volume (S29). When the memory usage rate of the virtual machine is between the first threshold Vth11 and the second threshold Vth12 (S30: YES), the management device 4 maintains the virtual machine in the present physical machine group (S31).

FIG. 13 illustrates a modified example of the process step S27 of FIG. 12. In FIG. 12, when the memory usage rate of the virtual machine is higher than the first threshold Vth11 and the virtual machine is already operating on a physical machine having the largest memory volume (S271: YES), the management device 4 migrates the virtual machine to a physical machine group having a higher memory operating frequency (S272). On the other hand, in FIG. 12, when the memory usage rate of the virtual machine is higher than the first threshold Vth11 and the virtual machine is not operating on a physical machine having the largest memory volume (S271: NO), the management device 4 migrates the virtual machine to a physical machine group having a larger memory volume (S27). By doing so, it is possible to eliminate a problem that the allocated memory volume is smaller than the set memory volume due to the over-commitment of the memory volume.

The management device 4 according to the third embodiment may control migration of virtual machines based on the CPU usage rate of the virtual machine and the CPU operating frequency and the number of CPU cores of the physical machine similarly to the first and second embodiments, and may control the migration of virtual machines based on the memory usage rate of the virtual machine and the memory volume and the memory operating frequency of the physical machine. In this case, for example, the migration control (1) of virtual machines based on the CPU usage rate of the virtual machine and the CPU operating frequency and the number of CPU cores of the physical machine may be executed with a higher frequency and the migration control (2) of virtual machines based on the memory usage rate of the virtual machine and the memory volume and the memory operating frequency of the physical machine may be executed with a lower frequency. Alternatively, the two types of migration control may be executed with the reverse frequencies. That is, the migration control frequencies of the migration control modes are different each other so that the timings of the migration controls are not synchronized.

### Fourth Embodiment

A fourth embodiment modifies the migration control of virtual machines according to the third embodiment. That is, in the fourth embodiment, first, when the memory usage rate, within a predetermined period, of a virtual machine is higher than the first threshold Vth11, the management device 4 migrates the virtual machine to a physical machine group having a higher memory operating frequency. In contrast, when the memory usage rate, within a predetermined period, of the virtual machine is lower than the second threshold Vth12, the management device 4 migrates the virtual machine to a physical machine group having a lower memory operating frequency. Moreover, when the memory usage rate of the virtual machine is between Vth11 and Vth12, the management device 4 maintains the virtual machine in the present physical machine group.

By performing such virtual machine allocation control, when the memory usage rate of a virtual machine becomes temporarily high and a larger amount of data is processed, the virtual machine migrates to a physical machine having a higher memory operating frequency. In this way, it is possible to increase the memory access speed of the virtual machine and to accelerate the processing speed of the virtual machine. In contrast, when the memory usage rate of a virtual machine becomes temporarily low and a smaller amount of data is processed, the virtual machine migrates to a physical machine having a lower memory operating frequency. In this way, it is possible to enable another virtual machine having a high memory usage rate to migrate to a physical machine having a high memory operating frequency.

When the memory usage rate of a virtual machine is higher than the first threshold Vth11 and the virtual machine is already operating on a physical machine having the highest memory operating frequency, the management device 4 migrates the virtual machine to a physical machine group having a larger memory volume. In this way, it is possible to eliminate the occurrence of a situation in which only a small memory volume is allocated to the virtual machine due to the over-commitment of the memory volume.

In the fourth embodiment, the management device 4 may control migration of virtual machines based on the CPU usage rate of the virtual machine and the CPU operating frequency and the number of CPU cores of the physical machine similarly to the first and second embodiments, and may control the migration of virtual machines based on the memory usage rate of the virtual machine and the memory volume and the memory operating frequency of the physical machine. For example, as described in the third embodiment, the migration control frequencies of the migration control modes may be different each other by changing the frequencies of the two types of virtual machine migration control.

According to the present embodiment, the management device 4 controls the virtual machines to migrate to an optimal physical machine to maximize the processing efficiency of the virtual machines and to accelerate the processing speed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing devices that include respectively processors having different operating frequencies; and
a management device that manages the plurality of information processing devices, wherein the management device includes:
a monitoring unit that monitors a usage rate, within a predetermined period, of a virtual machine executed by each of the plurality of information processing devices; and
an allocating unit that allocates a virtual machine, the usage rate of which within the predetermined period exceeds a first threshold, to another information processing device among the plurality of information processing devices, based on the number of processors of each of the plurality of information processing devices, the number of arithmetic processing units of each processor, and an operating frequency of each processor when the monitoring unit detects that the usage rate, within the predetermined period, of any one of the virtual machines exceeds the first threshold.

2. The information processing system according to claim 1, wherein
the usage rate, within the predetermined period, of the virtual machine is a usage rate, within a predetermined period, of the arithmetic processing unit allocated to the virtual machine.

3. The information processing system according to claim 2, wherein
the information processing device allocates a predetermined number of the arithmetic processing units in the information processing device to execute the virtual machine, and
when the usage rate, within the predetermined period, of the arithmetic processing unit allocated to the virtual machine is higher than the first threshold, the allocating unit migrates the virtual machine to another information processing device having an processor having a higher operating frequency than the information processing device currently executing the virtual machine.

4. The information processing system according to claim 3, wherein
when the usage rate, within the predetermined period, of the arithmetic processing unit allocated to the virtual machine is lower than a second threshold, which is lower than the first threshold, the allocating unit migrates the virtual machine to another information processing device having an processor having a lower operating frequency than the information processing device currently executing the virtual machine.

5. The information processing system according to claim 4, wherein
when the usage rate, within the predetermined period, of the arithmetic processing unit allocated to the virtual machine is between the first threshold and the second threshold, the allocating unit maintains the current allocation of the virtual machine to the information processing device.

6. The information processing system according to claim 3, wherein
when the usage rate, within the predetermined period, of the arithmetic processing unit allocated to the virtual machine is higher than the first threshold and the virtual machine is operating on a processor having the highest operating frequency, the allocating unit migrates the virtual machine to another information processing device having a processor having a larger number of arithmetic processing units than the information processing device currently executing the virtual machine.

7. The information processing system according to claim 1, wherein
the plurality of information processing devices have memories having different memory volumes and different memory operating frequencies,
the monitoring unit monitors a memory usage rate, within a predetermined period, of a virtual machine executed by each of the plurality of information processing devices, and
when the memory usage rate, within the predetermined period, of any one of the virtual machines exceeds a third threshold, the allocating unit allocates a virtual machine, the memory usage rate of which within the predetermined period exceeds the third threshold, to another information processing device among the plurality of information processing devices, based on a memory volume and a memory operating frequency of each of the plurality of information processing devices.

8. The information processing system according to claim 7, wherein
the information processing device allocates a predetermined memory volume in the information processing device to execute the virtual machine, and
when the memory usage rate, within the predetermined period, of the virtual machine is higher than the third threshold, the allocating unit migrates the virtual machine to another information processing device having a higher memory volume than the information processing device currently executing the virtual machine.

9. The information processing system according to claim 8, wherein
when the memory usage rate, within the predetermined period, of the virtual machine is lower than a fourth threshold, which is lower than the third threshold, the allocating unit migrates the virtual machine to another information processing device having a lower memory volume than the information processing device currently executing the virtual machine.

10. The information processing system according to claim 9, wherein
when the memory usage rate, within the predetermined period, of the virtual machine is between the third threshold and the fourth threshold, the allocating unit maintains the current allocation of the virtual machine to the information processing device.

11. The information processing system according to claim 8, wherein
when the memory usage rate, within the predetermined period, of the virtual machine is higher than the third threshold and the virtual machine is operating on a processor having the largest memory volume, the allocating unit migrates the virtual machine to another information processing device having a processor having a higher memory operating frequency than the information processing device currently executing the virtual machine.

12. The information processing system according to claim 7, wherein
the information processing device allocates a predetermined memory volume in the information processing device to execute the virtual machine, and
when the memory usage rate, within the predetermined period, of the virtual machine is higher than the third threshold, the allocating unit migrates the virtual machine to another information processing device having a higher memory operating frequency than the information processing device currently executing the virtual machine.

13. The information processing system according to claim 12, wherein
when the memory usage rate, within the predetermined period, of the virtual machine is higher than the third threshold and the virtual machine is operating on a processor having the highest memory operating frequency, the allocating unit migrates the virtual machine to another information processing device having a processor having a higher memory volume than the information processing device currently executing the virtual machine.

14. The information processing system according to claim 7, wherein
the allocating unit executes first allocation control of allocating a virtual machine, the usage rate of which within the predetermined period exceeds the first threshold, to another information processing device, based on the number of processors of each of the plurality of information processing devices, the number of arithmetic processing units of each processor, and the operating frequency of each processor, and second allocation control of allocating a virtual machine, the memory usage rate of which within the predetermined period exceeds the third threshold, to another information processing device, based on the memory volume and the memory operating frequency of each of the plurality of information processing devices, with the first allocation control and the second allocation control being executed in different t.

15. A management device, which manages a plurality of information processing device, each of which includes processors having different operating frequencies, comprising:
a monitoring unit that monitors a usage rate, within a predetermined period, of a virtual machine executed by each of the plurality of information processing devices; and
an allocating unit that allocates a virtual machine, the usage rate of which within the predetermined period exceeds a first threshold, to another information processing device among the plurality of information processing devices, based on the number of processors of each of the plurality of information processing devices, the number of arithmetic processing units of each processor, and an operating frequency of each processor when the monitoring unit detects that the usage rate, within the predetermined period, of any one of the virtual machines exceeds the first threshold.

16. The management device according to claim 15, wherein
the plurality of information processing devices have memories having different memory volumes and different memory operating frequencies,
the monitoring unit monitors a memory usage rate, within a predetermined period, of a virtual machine executed by each of the plurality of information processing devices, and
when the memory usage rate, within the predetermined period, of any one of the virtual machines exceeds a third threshold, the allocating unit allocates a virtual machine, the memory usage rate of which within the predetermined period exceeds the third threshold, to another information processing device among the plurality of information processing devices, based on a memory volume and a memory operating frequency of each of the plurality of information processing devices.

17. A method of controlling an information processing system, which includes a plurality of information processing devices that include respectively processors having different operating frequencies, and a management device that manages the plurality of information processing devices, the method comprising:
monitoring a usage rate, within a predetermined period, of a virtual machine executed by each of the plurality of information processing devices; and
allocating a virtual machine, the usage rate of which within the predetermined period exceeds a first threshold, to another information processing device among the plurality of information processing devices, based on the number of processors of each of the plurality of information processing devices, the number of arithmetic processing units of each processor, and an operating frequency of each processor when the monitoring unit detects that the usage rate, within the predetermined period, of any one of the virtual machines exceeds the first threshold.
